(19) United States
(12) Patent Application Publication
(10) Pub. No.: US 2026/0307244 A1
(43) Pub. Date: Oct. 8, 2026

(54) CONTROL DEVICE, CONTROL METHOD FOR ROBOT, AND ROBOT CONTROL SYSTEM

(71) Applicant: PANASONIC INTELLECTUAL PROPERTY MANAGEMENT CO., LTD., Osaka (JP)

(72) Inventors: Daiki MURAKAMI, Osaka (JP); Kiyoshi SANO, Kanagawa (JP); Michitaka SAKON, Kanagawa (JP); Masanari MORISHITA, Osaka (JP)

(73) Assignee: PANASONIC INTELLECTUAL PROPERTY MANAGEMENT CO., LTD., Osaka (JP)

(21) Appl. No.: 19/547,129

(22) Filed: Feb. 23, 2026

(30) Foreign Application Priority Data
Apr. 7, 2025 (JP) 2025-063334

(51) Int. Cl. B25J 9/16; B25J 15/00; B25J 15/06

(52) U.S. Cl. CPC B25J 9/1612; B25J 9/1697; B25J 15/0052; B25J 15/0616

(57) ABSTRACT

There is provided a control device that controls a robot for picking an object, the control device configured to: acquire a captured image; detect the object from the captured image; select an end effector for picking the object from among a plurality of different end effectors included in the robot based on the detected object; determine a camera to be used for estimating a picking position of the object from among a first camera that is provided integrally with the end effector and captures an image of the object and a second camera that is provided separately from the end effector and captures an image of an area where the object is picked, based on the captured image and information on the selected end effector; and cause the robot to pick the object using the determined first camera or second camera and the selected end effector.

### CROSS-REFERENCE TO RELATED APPLICATIONS

This application is based on and claims priority under 35 USC 119 from Japanese Patent Application No. 2025-063334 filed on April 7, 2025, the contents of which are incorporated herein by reference.

### TECHNICAL FIELD

The present disclosure relates to a control device, a control method for a robot, and a robot control system.

### BACKGROUND ART

JP2024-035630A discloses a gripping device including a first camera that captures an image of at least one workpiece, a gripping unit having a hand that grips the workpiece, a second camera that is disposed in the gripping unit and captures an image of the hand, and a control device that controls the first camera, the second camera, and the gripping unit. The gripping device acquires a gripping success rate of each of the at least one workpiece based on a first image captured by the first camera, determines a target workpiece from the at least one workpiece based on each gripping success rate, moves the gripping unit until a distance between the hand and the target workpiece becomes a first predetermined distance, acquires a second image by causing the second camera to capture an image after moving the gripping unit, acquires a first gripping position of the target workpiece based on the second image, and outputs a control signal for causing the gripping unit to grip the target workpiece at the first gripping position.

### SUMMARY OF INVENTION

The present disclosure provides a control device, a control method for a robot, and a robot control system that increase a speed or accuracy of picking an object using a robot.

According to an illustrative aspect of the present disclosure, a control device that controls a robot for picking an object, includes: an acquisition unit configured to acquire a captured image; a detection unit configured to detect the object from the captured image; a selection unit configured to select an end effector for picking the object from among a plurality of different end effectors included in the robot based on the detected object; a determination unit configured to determine a camera to be used for estimating a picking position of the object from among a first camera that is provided integrally with the end effector and captures an image of the object and a second camera that is provided separately from the end effector and captures an image of an area where the object is picked, based on the captured image and information on the selected end effector; and a control unit configured to cause the robot to pick the object using the determined first camera or second camera and the selected end effector.

According to another illustrative aspect of the present disclosure, a control method for a robot performed by a control device that controls a robot for picking an object, includes: acquiring a captured image; detecting the object from the captured image; selecting an end effector for picking the object from among a plurality of different end effectors included in the robot, based on the select object; determining a camera to be used for estimating a picking position of the object from among a first camera that is provided integrally with the end effector and captures an image of the object and a second camera that is provided separately from the end effector and captures an image of an area where the object is picked, based on the captured image and information on the selected end effector; and causing the robot to pick the object using the determined first camera or second camera and the selected end effector.

According to another illustrative aspect of the present disclosure, a robot control system includes: a robot including a plurality of different end effectors and configured to pick an object; a first camera provided integrally with the end effector and configured to capture an image of the object; a second camera provided separately from the end effector and configured to capture an image of an area where the object is picked; and a control device configured to communicate with the robot, the first camera, and the second camera and control the robot. The second camera acquires a captured image, and the control device: detects the object from the captured image; selects an end effector for picking the object from among the plurality of different end effectors based on the select object; determines a camera to be used for estimating a picking position of the object from among the first camera and the second camera, based on the captured image and information on the selected end effector; and causes the robot to pick the object using the determined first camera or second camera and the selected end effector.

According to the present disclosure, it is possible to increase the speed or accuracy of picking an object using a robot.

### BRIEF DESCRIPTION OF DRAWINGS

FIG. 1 is a diagram illustrating an overall configuration example of a picking system according to an embodiment;

FIG. 2 is a flowchart illustrating an operation procedure example of a control device according to the embodiment;

FIG. 3 is a flowchart illustrating the operation procedure example of a control device according to the embodiment;

FIG. 4 is a diagram illustrating a picking example of an object by an overview camera and a gripper;

FIG. 5 is a diagram illustrating a picking example of an object by a hand camera and a gripper;

FIG. 6 is a diagram illustrating a picking example of an object by the overview camera and a suction pad; and

FIG. 7 is a diagram illustrating a picking example of an object by the hand camera and the suction pad.

### DESCRIPTION OF EMBODIMENTS

### Background of Present Disclosure

A warehouse for receiving, storing, packing, shipping, or the like of goods is required to automate work using a robot or the like in order to reduce a manual work load. With an increase in the number of goods in recent years, further improvement in efficiency related to a series of works is required. In such a warehouse, since articles having various shapes or attributes (hereinafter, also referred to as "products" or "objects") are handled, it is necessary for a person or a robot to share works in consideration of characteristics of the products. As one of such works, there is a picking work of transferring a product from an accommodation unit (hereinafter, referred to as a "storage bin") in which the product is accommodated to an accommodation unit (hereinafter, referred to as a "shipping bin") that accommodates one or a plurality of products to be shipped based on a shipping instruction.

A picking work of the related art includes a work method executed by a camera used for works using an overview camera that is a 3D camera and is capable of observing an area including a picking area in which a product is picked and an arrangement area in which the picked product is arranged and accommodated in an overview, a work method executed by a hand camera that is installed in a hand portion of a robot and is capable of capturing an image of a product from close proximity where the overview camera would interfere with the robot, and the like. In a picking work using the overview camera, since an operation of the robot and imaging by the overview camera can be executed at the same time, it is possible to speed up a work time by estimating a picking position of the product during an arrangement control of the robot and estimating an arrangement position of the product during a picking control of the robot. In addition, in a picking work using the hand camera, since the image of the product can be captured from a nearby position, it is possible to pick a small product and to estimate a picking position with high accuracy.

However, in the picking work using the overview camera, since the entire picking area or the entire arrangement area is imaged, there is a problem that a distance between the overview camera and the product increases and an estimation error of the picking position or the arrangement position is large. In addition, in the picking work using the hand camera, an additional takt is required to move the hand portion closer to the product, which can lead to issues such as a longer takt time, or depending on the size of the product, the picked product may be captured in the field of view of the hand camera, making it difficult to estimate the arrangement position.

Therefore, in the following embodiment, examples of a control device, a control method for a robot, and a robot control system that increase a speed or accuracy of picking an object using a robot will be described.

Hereinafter, the embodiment specifically disclosing configurations and operations of a control device, a control method for a robot, and a robot control system according to the present disclosure will be described in detail with reference to the drawings as appropriate. However, unnecessarily detailed description may be omitted. For example, detailed description of well-known matters and redundant description of substantially the same configuration may be omitted. This is to avoid unnecessary redundancy of the following descriptions and to facilitate understanding of those skilled in the art. The accompanying drawings and the following description are provided for those skilled in the art to fully understand the present disclosure, and are not intended to limit the subject matters described in the claims.

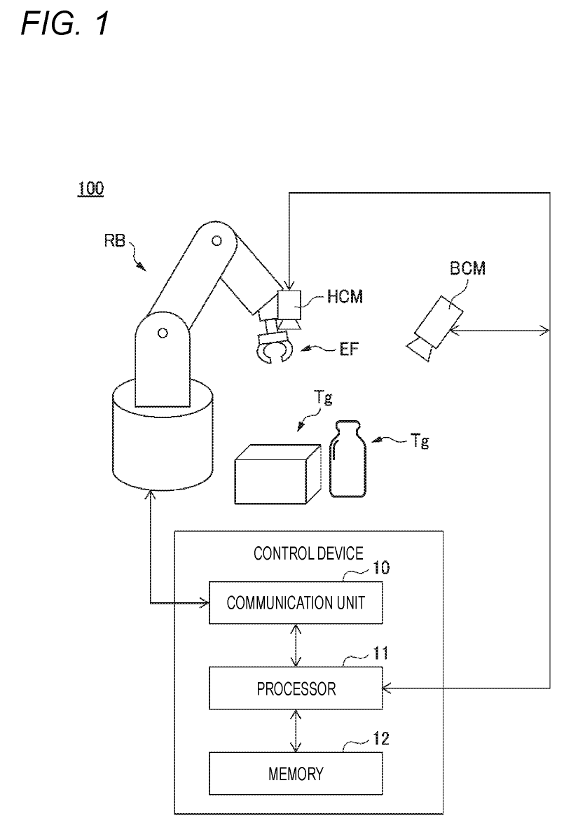

First, a picking system 100 according to the embodiment will be described with reference to FIG. 1. FIG. 1 is a diagram illustrating an overall configuration example of the picking system 100 according to the embodiment.

The picking system 100 illustrated in FIG. 1 is an example and is not limited thereto. For example, the number of picking robots RB controlled by one control device P1 may be plural. Further, the picking robot RB illustrated in FIG. 1 illustrates an example in which only a gripper is provided as an end effector EF, but actually, a gripper GR and a suction pad PD as a plurality of end effectors EF capable of picking an object Tg by different methods are provided.

The picking system 100 is a system that picks an object as a picking target by the picking robot RB and transports the object to a predetermined arrangement position. The picking system 100 includes the control device P1, the picking robot RB, a hand camera HCM, and an overview camera BCM.

The control device P1 is connected to the picking system 100, the hand camera HCM, and the overview camera BCM so as to be able to perform data communication. The control device P1 controls each of the picking system 100, the hand camera HCM, and the overview camera BCM. The control device P1 includes a communication unit 10, a processor 11, and a memory 12.

The communication unit 10 is connected to the picking system 100, the hand camera HCM, and the overview camera BCM so as to be capable of wired communication or wireless communication, and transmits and receives data. The wireless communication here is, for example, short-range wireless communication such as Bluetooth (registered trademark) or NFC (registered trademark), or communication via a wireless local area network (LAN) such as Wi-Fi (registered trademark).

The communication unit 10 outputs various data transmitted from the picking system 100, the hand camera HCM, or the overview camera BCM to the processor 11. The communication unit 10 transmits various data output from the processor 11 to the picking system 100, the hand camera HCM, or the overview camera BCM.

The processor 11 is implemented by using, for example, a central processing unit (hereinafter referred to as a "CPU") or a field programmable gate array (hereinafter referred to as a "FPGA"), and executes various kinds of processing and controls in cooperation with the memory 12. Specifically, the processor 11 implements each function by referring to a program and data stored in the memory 12 and executing the program.

The memory 12 includes, for example, a random access memory (hereinafter, referred to as a "RAM") as a work memory used when each processing of the processor 11 is performed, and a read only memory (hereinafter, referred to as a "ROM") storing a program and data defining each operation of the processor 11. The RAM temporarily stores data or information generated or acquired by the processor 11. The program that defines the operation of the processor 11 is written in the ROM.

The picking robot RB is an articulated robot to which the end effector EF can be attached. The picking robot RB is controlled by the control device P1 to execute a picking work of picking the object Tg and transporting the object Tg to a predetermined arrangement position. The picking robot RB includes a plurality of end effectors EF and the hand camera HCM. The picking robot RB is realized as the plurality of end effectors EF by the suction pad PD that sucks and picks a surface of the object Tg and the gripper GR that grips and picks the object Tg. The combination of the end effectors EF is not limited to the example described above.

The hand camera HCM includes at least a lens (not illustrated) and an image sensor (not illustrated). The image sensor is, for example, a solid-state imaging element such as a charged-coupled device (hereinafter referred to as a "CCD") or a complementary metal oxide semiconductor (hereinafter referred to as a "CMOS"), and converts an optical image formed on an imaging surface into an electric signal. The hand camera HCM executes imaging according to a control instruction to start imaging transmitted from the control device P1. The hand camera HCM outputs the captured image to the processor 11 of the control device P1. Although not illustrated in FIG. 1, the hand camera HCM outputs the captured image to the processor 11 via the communication unit 10.

The hand camera HCM is provided on the end effector EF and captures an image of the product picked by the suction pad PD and the gripper GR. The hand camera HCM may be provided at any position where the hand camera HCM can capture the image of the product as the picking target and does not interfere with the product and the suction pad PD and the gripper GR holding the product.

The overview camera BCM includes at least a lens (not illustrated) and an image sensor (not illustrated). The image sensor is, for example, a solid-state imaging device such as a CCD or a CMOS, and converts an optical image formed on an imaging surface into an electrical signal. The overview camera BCM executes imaging according to a control instruction to start imaging transmitted from the control device P1. The overview camera BCM outputs the captured image to the processor 11 of the control device P1. Although not illustrated in FIG. 1, the overview camera BCM outputs the captured image to the processor 11 via the communication unit 10.

The overview camera BCM captures an image of an area including a picking area in which the object Tg is picked and an arrangement area in which the picked object Tg is arranged. The overview camera BCM may be installed at a position where the picking area and the arrangement area can be imaged.

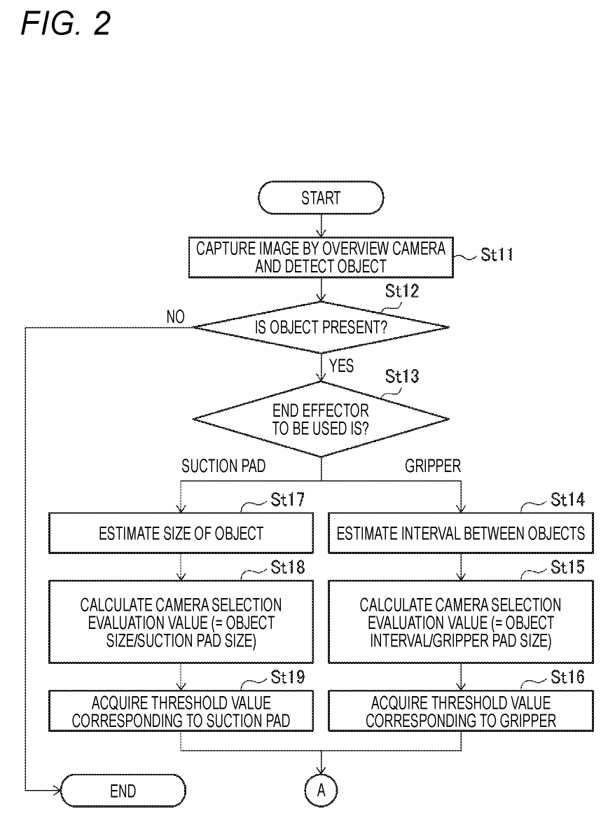

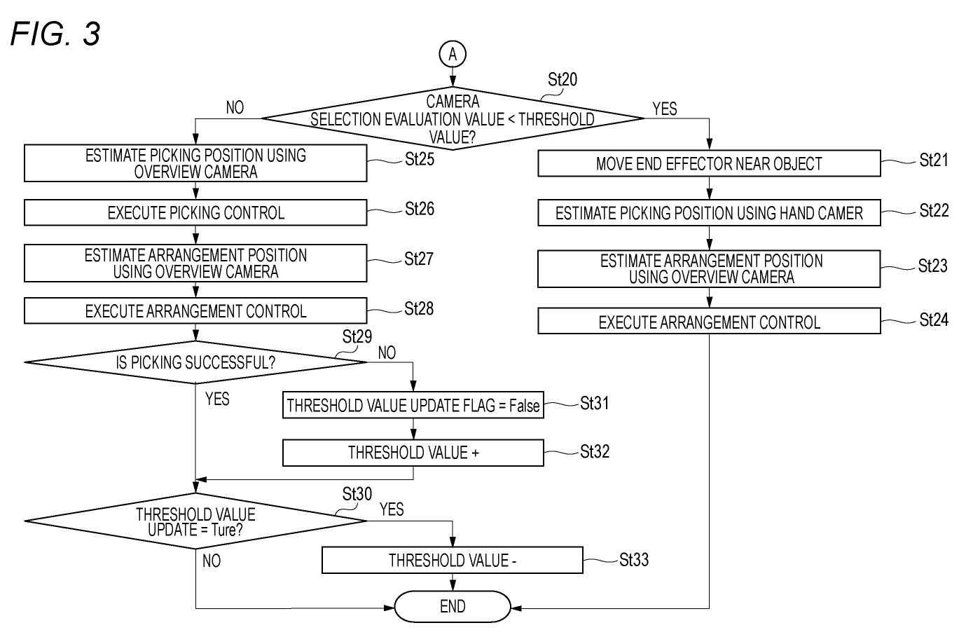

Next, an operation procedure example of the picking system 100 will be described with reference to FIGS. 2 and 3. FIG. 2 is a flowchart illustrating an operation procedure example of the control device P1 according to the embodiment. FIG. 3 is a flowchart illustrating the operation procedure example of the control device P1 according to the embodiment.

The control device P1 causes the overview camera BCM to capture the image of the picking area and the arrangement area (St11). The control device P1 analyzes a captured image (hereinafter, referred to as a "overview image") captured by the overview camera BCM and detects the object Tg (St11).

The control device P1 determines whether the object Tg as the picking target is detected, that is, whether the object Tg is present in the picking area (St12).

When it is determined in step St12 that the object Tg as the picking target is detected, that is, the object Tg is present in the picking area (St12, YES), the control device P1 determines which of the suction pad PD and the gripper GR is to be used as the end effector EF used for picking the object Tg (St13). The end effector EF may be determined by any method. For example, the control device P1 may identify the detected object Tg and select the end effector EF set in advance based on an identification result, or may determine the end effector EF based on a size, weight, material, or the like of the object Tg with reference to a product database or the like from the object Tg indicated by the identification result.

On the other hand, when it is determined in step St12 that the object Tg as the picking target is not detected, that is, the object Tg is not present in the picking area (St12, NO), the control device P1 ends the picking work.

In step St13, when it is determined that the gripper GR is used (St13, gripper), the control device P1 estimates an interval (distance) between the object Tg as the picking target and another object around the object Tg or a storage bin in which the object Tg is accommodated based on the overview image (St14). The interval (distance) between the objects Tg estimated here is a distance between the object Tg and the other object in a picking direction in which the gripper GR picks the object Tg and in an operation direction in which claws of the gripper GR open and close.

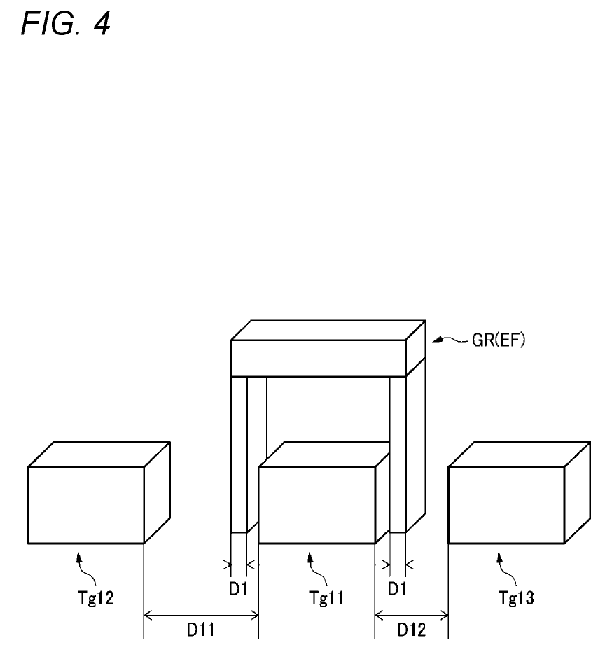

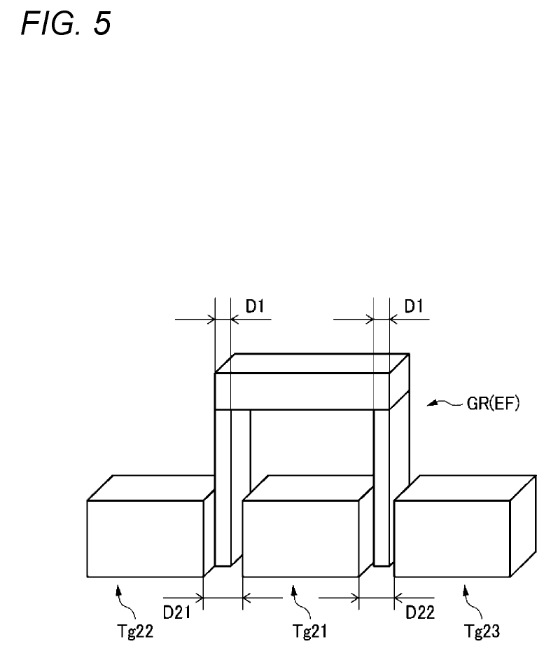

The control device P1 divides the estimated interval (distance) between the objects Tg by a gripper pad size D1 of the gripper GR to calculate a camera selection evaluation value for selecting a camera to be used (St15). For example, the camera selection evaluation value illustrated in FIG. 4 is a value (= D12/D1) obtained by dividing the smaller interval D12 of intervals D11 and D12 of an object Tg11 by the gripper pad size D1. The camera selection evaluation value illustrated in FIG. 5 is a value (= D22/D1) obtained by dividing the smaller interval D22 of intervals D21 and D22 of an object Tg21 by the gripper pad size D1.

The control device P1 acquires a threshold value corresponding to the gripper GR (St16). When there is no calculated threshold value, the control device P1 acquires a preset initial value as the threshold value. The initial value is set to, for example, a value obtained by doubling the gripper pad size D1.

On the other hand, when it is determined in step St13 that the suction pad PD is used (St13, suction pad), the control device P1 estimates a size of a suction surface of the object Tg as the picking target based on the overview image (St17).

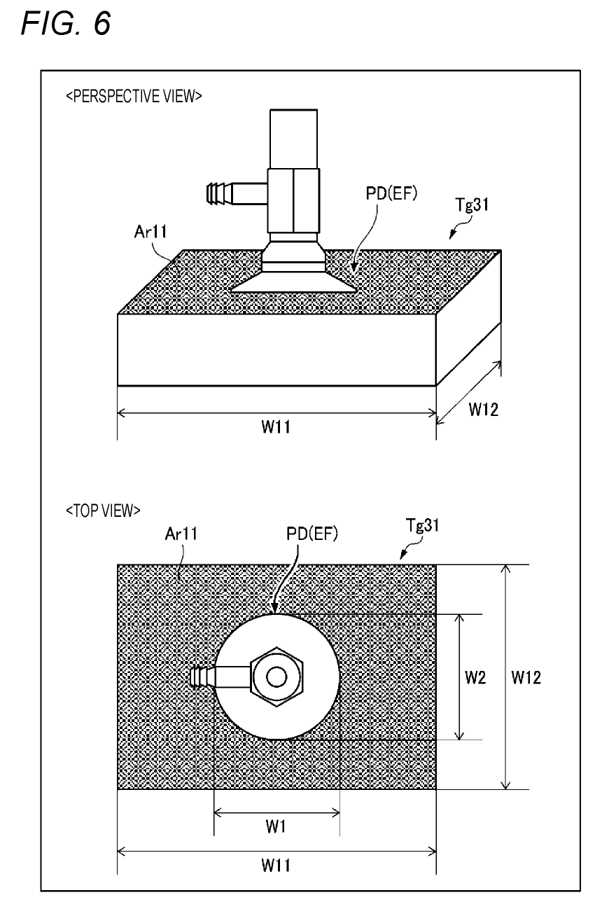

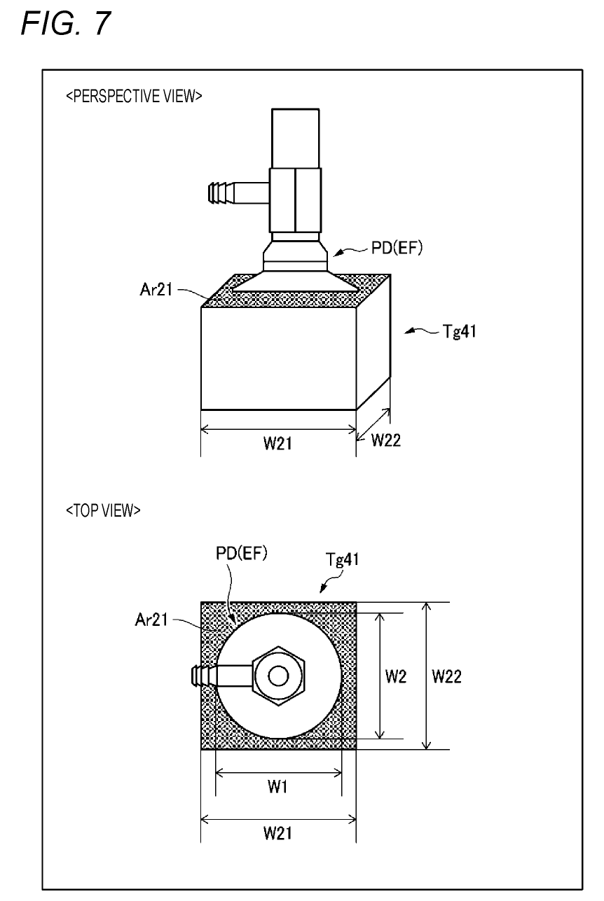

The control device P1 calculates the camera selection evaluation value for selecting a camera to be used by dividing the estimated size of the object Tg by the size of a suction portion of the suction pad PD (suction pad size, see FIG. 6) (St18). For example, the camera selection evaluation value illustrated in FIG. 6 is a value (= (W11 × W12)/(W1 × W2) obtained by dividing the size of an object Tg31 based on a width W11 and a depth W12 of the object Tg31 by the suction pad size based on a width W1 and a depth W2 of the suction pad PD. The camera selection evaluation value illustrated in FIG. 7 is a value (= (W21 × W22)/(W1 × W2) obtained by dividing a size of an object Tg41 based on a width W21 and a depth W22 of the object Tg41 by the suction pad size based on a width W1 and a depth W2 of the suction pad PD.

The control device P1 acquires a threshold value corresponding to the suction pad PD (St19). When there is no calculated threshold value, the control device P1 acquires a preset initial value as the threshold value. The initial value is set to, for example, a value obtained by doubling the suction pad size.

The control device P1 determines whether the camera selection evaluation value is less than the threshold value (St20). Specifically, comparison processing between the camera selection evaluation value and the threshold value when the end effector EF is the gripper GR is determination processing of determining whether the gripper GR can execute the picking operation without high-accuracy picking position estimation processing using the hand camera HCM based on the gripper pad size with respect to the interval between the object and another object present around the object. The comparison processing between the camera selection evaluation value and the threshold value when the end effector EF is the suction pad PD is determination processing of determining whether the suction pad PD can execute the picking operation without high-accuracy picking position estimation processing using the hand camera HCM based on the suction pad size with respect to the size of the suction surface of the object. Accordingly, the control device P1 determines whether the picking work using only the overview camera BCM is possible in the picking control of the object Tg.

When it is determined in step St20 that the camera selection evaluation value is less than the threshold value (St20, YES), the control device P1 generates a control command for moving the end effector EF (the gripper GR or the suction pad PD) close to the object Tg based on the estimated position of the object Tg, and transmits the control command to the picking robot RB (St21).

After the picking robot RB moves close to the object Tg, the control device P1 causes the hand camera HCM to capture an image of the object Tg (St22). The control device P1 estimates the picking position where the end effector EF picks the object Tg based on a captured image (hereinafter, referred to as a "nearby image") captured by the hand camera HCM (St22).

The control device P1 causes the overview camera BCM to capture an image of the arrangement area while the picking robot RB is executing the picking operation of the object Tg (St23). The control device P1 estimates the arrangement position where the picked object Tg is arranged based on the overview image captured by the overview camera BCM (St23). The control device P1 generates a control command for arranging the object Tg at the estimated arrangement position, and transmits the control command to the picking robot RB (St24).

On the other hand, when it is determined in step St20 that the camera selection evaluation value is not less than the threshold value (St20, NO), the control device P1 causes the overview camera BCM to capture the image of the picking area (St25). The control device P1 estimates the picking position where the end effector EF picks the object Tg based on the overview image captured by the overview camera BCM (St25). The control device P1 generates the control command for picking the object Tg at the estimated picking position and transmits the control command to the picking robot RB (St26).

The control device P1 causes the overview camera BCM to capture the image of the arrangement area while the picking robot RB is executing the picking operation of the object Tg (St27). The control device P1 estimates the arrangement position where the picked object Tg is arranged based on the overview image captured by the overview camera BCM (St27). The control device P1 generates the control command for arranging the object Tg at the estimated arrangement position, and transmits the control command to the picking robot RB (St28).

The control device P1 determines whether the picking of the object Tg is successful by the picking control based on the overview image (St29). The determination of whether the picking is successful may be executed by any method.

In step St29, when it is determined that the picking of the object Tg is successful by the picking control based on the overview image (St29, YES), the control device P1 determines whether an update flag of the threshold value set in the end effector EF (the gripper GR or the suction pad PD) is true, that is, whether to update a current threshold value (St30).

On the other hand, in step St29, when it is determined that the picking of the object Tg is not successful by the picking control based on the overview image (St29, NO), the control device P1 sets the update flag of the threshold value to false (St31). The control device P1 updates (changes) the current threshold value set for the end effector EF (the gripper GR or the suction pad PD) to a larger value, that is, a threshold value for executing the picking control using the overview camera BCM even if the camera selection evaluation value is larger (St32).

In step St30, when it is determined that the update flag of the threshold value set in the end effector EF is true (St30, YES), the control device P1 updates (changes) the current threshold value set in the end effector EF (the gripper GR or the suction pad PD) to a smaller value, that is, a threshold value for executing the picking control using the hand camera HCM when the current camera selection evaluation value is met (St33).

On the other hand, when it is determined in step St30 that the update flag of the threshold value set in the end effector EF is not true (St30, NO), the control device P1 ends the operation procedure.

Although an example in which the operation procedure described above ends after the processing of step St24, step St30, or step St33 is executed is illustrated in order to make the description easy to understand, the operation procedure illustrated in FIGS. 2 and 3 may be repeatedly executed.

Accordingly, the control device P1 according to the embodiment can set the threshold value more suitable for the picking robot RB for each end effector EF (the gripper GR or the suction pad PD) in the picking works of various objects Tg executed by the picking robot RB. By setting the threshold value more suitable for the picking robot RB, the control device P1 can determine with higher accuracy whether the picking control of the object Tg using only the overview camera BCM is possible. Therefore, in the picking control of the end effector EF, the control device P1 can further speed up a takt time of the picking work by minimizing the object Tg to be a target of the picking control using the hand camera HCM.

As a result, by setting the threshold value more suitable for the picking robot RB for each end effector EF (the gripper GR or the suction pad PD), the control device P1 according to the embodiment can reduce a probability of failure in picking the object Tg, and can further improve the accuracy of picking the object Tg by the picking robot RB.

The operation procedure described above may be executed once or a plurality of times before start of an operation, or may be executed a plurality of times during an operation. The control device P1 according to the embodiment executes the operation procedure illustrated in FIGS. 2 and 3 before the start of the operation, and thus, since a more suitable threshold value is set for the picking robot RB at the start of the operation, it is possible not only to reduce picking failure during the operation but also to further shorten the takt time during the operation. In addition, the control device P1 according to the embodiment can contribute to a decrease in picking failure during the operation even if the threshold value is not set in advance by repeatedly executing the operation procedure described above during the operating, and can shorten the takt time during the operation as compared with the takt time of the related art.

Next, picking examples by the gripper GR will be described with reference to FIGS. 4 and 5. FIG. 4 is a diagram illustrating the picking example of the object Tg11 by the overview camera BCM and the gripper GR. FIG. 5 is a diagram illustrating the picking example of the object Tg21 by the hand camera HCM and the gripper GR. In FIGS. 4 and 5, the picking examples of the objects Tg11 and Tg21 each having a rectangular parallelepiped shape will be described for easy understanding of the description.

The picking example of the object Tg11 in FIG. 4 illustrates a case where the gripper GR is selected as the end effector EF and the camera selection evaluation value (= D12/D1) is equal to or greater than the threshold value corresponding to the gripper GR. The processing from calculation processing of the camera selection evaluation value to the picking operation of the object Tg11 will be specifically described with reference to FIG. 4.

In the example illustrated in FIG. 4, when the picking direction in which the gripper GR picks the object Tg11 is set in advance, the control device P1 determines whether it is necessary to estimate the picking position with high accuracy using the hand camera HCM for the picking operation of the object Tg11 by the gripper GR based on the overview image. First, the control device P1 detects the object Tg11 and the plurality of objects Tg12 and Tg13 existing in an opening and closing direction of the claws of the gripper GR picking the object Tg11 based on the overview image. The control device P1 calculates the intervals (distances) D11 and D12 between the detected objects Tg12 and Tg13 and the object Tg11 as the picking target based on the overview image.

The control device P1 calculates the camera selection evaluation value (= D12/D1) based on the smaller interval D12 of the calculated intervals D11 and D12, which is more likely to require highly accurate estimation of the picking position using the hand camera HCM, and the gripper pad size D1. The control device P1 determines that the camera selection evaluation value is equal to or greater to the threshold value by comparing the latest threshold value corresponding to the gripper GR with the camera selection evaluation value, and determines execution of the picking operation using the overview camera BCM.

The control device P1 causes the overview camera BCM to execute imaging processing, and estimates the picking position of the object Tg11 based on the object Tg11 appearing in the overview image. The control device P1 moves the gripper GR to the estimated picking position and executes the picking operation.

The picking example of the object Tg21 in FIG. 5 illustrates a case where the gripper GR is selected as the end effector EF and the camera selection evaluation value (= D22/D1) is equal to or greater than the threshold value corresponding to the gripper GR. The processing from the calculation processing of the camera selection evaluation value to the picking operation of the object Tg21 will be specifically described with reference to FIG. 5.

In the example illustrated in FIG. 5, when the picking direction of the object Tg21 by the gripper GR is set in advance, the control device P1 detects the object Tg21 and a plurality of objects Tg22 and Tg23 present in the opening and closing direction of the claws of the gripper GR that picks the object Tg11 based on the overview image. The control device P1 calculates the intervals (distances) D21 and D22 between the detected objects Tg22 and Tg23 and the object Tg21 as the picking target based on the overview image.

The control device P1 calculates the camera selection evaluation value (= D22/D1) based on the smaller interval D22 of the calculated intervals D21 and D22, which is more likely to require highly accurate estimation of the picking position using the hand camera HCM, and the gripper pad size D1. The control device P1 determines that the camera selection evaluation value is less than the threshold value by comparing the latest threshold value corresponding to the gripper GR with the camera selection evaluation value, and determines execution of the picking operation using the hand camera HCM.

The control device P1 moves the gripper GR to a vicinity of the object Tg21 based on the overview image and causes the hand camera HCM to execute the imaging processing. The control device P1 estimates the picking position of the object Tg21 with higher accuracy based on the object Tg21 appearing in the captured nearby image. The control device P1 moves the gripper GR to the estimated picking position and executes the picking operation.

In the example described above, the example in which the picking directions of the objects Tg11 and Tg21 by the gripper GR are set in advance has been described, but the picking directions of the objects Tg11 and Tg21 may be determined based on the overview image. In such a case, the control device P1 determines from which direction the objects Tg11 and Tg21 are picked as the picking direction of the objects Tg11 and Tg21 based on the overview image. Specifically, the control device P1 detects the objects Tg11 and Tg21 and objects, obstacles, trays, or the like around the objects Tg11 and Tg21 based on the overview image, and calculates intervals (distances) between the detected objects and the objects Tg11 and Tg21. The control device P1 determines a straight line having a combination of wider intervals (distances) as the picking direction in which the objects Tg11 and Tg21 are picked based on the calculated intervals (distances) between the detected objects and the objects Tg11 and Tg21.

Next, picking examples by the suction pad PD will be described with reference to FIGS. 6 and 7. FIG. 6 is a diagram illustrating the picking example of the object Tg31 by the overview camera BCM and the suction pad PD. FIG. 7 is a diagram illustrating the picking example of the object Tg41 by the hand camera HCM and the suction pad PD. In FIGS. 6 and 7, the picking examples of the objects Tg31 and Tg41 each having a rectangular parallelepiped shape will be described for easy understanding of the description.

The picking example of the object Tg31 in FIG. 6 illustrates a case where the suction pad PD is selected as the end effector EF and the camera selection evaluation value (= (W11 × W12)/(W1 × W2) is equal to or greater than the threshold value corresponding to the suction pad PD. The processing from the calculation processing of the camera selection evaluation value to the picking operation of the object Tg31 will be specifically described with reference to FIG. 6.

In the example illustrated in FIG. 6, the control device P1 determines whether it is necessary to estimate the picking position with high accuracy using the hand camera HCM for the picking operation of the object Tg31 by the suction pad PD based on the overview image. First, the control device P1 detects a picking surface of the object Tg31 based on the overview image. The control device P1 calculates each of the width W11 and the depth W12 of the picking surface of the detected object Tg31 based on the overview image, and calculates the size of the object Tg31.

The control device P1 calculates the camera selection evaluation value (= (W11 × W12)/(W1 × W2) based on the calculated size of the object Tg31 and the suction pad size (= W1 × W2). The control device P1 determines that the camera selection evaluation value is equal to or greater to the threshold value by comparing the latest threshold value corresponding to the suction pad PD with the camera selection evaluation value, and determines the execution of the picking operation using the overview camera BCM.

The control device P1 causes the overview camera BCM to execute the imaging processing, and estimates the picking position of the object Tg31 based on the object Tg31 appearing in the overview image. The control device P1 moves the suction pad PD to the estimated picking position and executes the picking operation.

The picking example of the object Tg41 in FIG. 7 illustrates a case where the suction pad PD is selected as the end effector EF and the camera selection evaluation value (= (W21 × W22)/(W1 × W2) is equal to or greater than the threshold value corresponding to the suction pad PD. The processing from the calculation processing of the camera selection evaluation value to the picking operation of the object Tg41 will be specifically described with reference to FIG. 7.

In the example illustrated in FIG. 7, the control device P1 calculates the camera selection evaluation value (= (W21 × W22)/(W1 × W2) based on the calculated size of the object Tg41 and the suction pad size (= W1 × W2). The control device P1 determines that the camera selection evaluation value is less than the threshold value by comparing the latest threshold value corresponding to the suction pad PD with the camera selection evaluation value, and determines the execution of the picking operation using the hand camera HCM.

The control device P1 moves the suction pad PD to a vicinity of the object Tg41 based on the overview image, and causes the hand camera HCM to execute the imaging processing. The control device P1 causes the overview camera BCM to execute the imaging processing based on the object Tg41 appearing in the captured nearby image, and estimates the picking position of the object Tg41 with higher accuracy. The control device P1 moves the suction pad PD to the estimated picking position and executes the picking operation.

### Appendix

The following techniques are disclosed based on the above description of the embodiment.

### Technique 1

A control device P1 that controls a robot (the picking robot RB) for picking an object, includes:

an acquisition unit (the communication unit 10) configured to acquire a captured image;

a detection unit (the processor 11) configured to detect the object from the captured image;

a selection unit (the processor 11) configured to select an end effector EF for picking the object from among a plurality of different end effectors EF included in the robot (the picking robot RB) based on the detected object;

a determination unit (the processor 11) configured to determine a camera to be used for estimating a picking position of the object from among a first camera (the hand camera HCM) that is provided integrally with the end effector EF and captures an image of the object and a second camera (the overview camera BCM) that is provided separately from the end effector EF and captures an image of an area where the object is picked, based on the captured image and information on the selected end effector (that is, a situation of the object as a picking target as viewed from the gripper GR or the suction pad PD, such as an interval between the object and an object around the object or a size of a suction surface of the object); and

a control unit (the processor 11) configured to cause the robot (the picking robot RB) to pick the object using the determined first camera (the hand camera HCM) or second camera (the overview camera BCM) and the selected end effector EF.

Accordingly, when it is determined that the picking control using the overview camera BCM is possible based on the picking situation of the object with respect to the selected end effector EF, the control device P1 causes the picking robot RB to execute the picking control using the overview camera BCM. Therefore, in the picking control of the end effector EF, the control device P1 can further speed up a takt time of a picking work by minimizing the object Tg to be a target of the picking control using the hand camera HCM.

### Technique 2

In the control device P1 according to Technique 1,

the determination unit (the processor 11) calculates an evaluation value (the camera selection evaluation value) indicating a picking situation of the object with respect to the end effector EF, determines the camera as the first camera (the hand camera HCM) when it is determined that the evaluation value (the camera selection evaluation value) is less than a threshold value corresponding to the end effector EF, and determines the camera as the second camera (the overview camera BCM) when it is determined that the evaluation value (the camera selection evaluation value) is not less than the threshold value corresponding to the selected end effector EF.

Accordingly, the control device P1 can determine whether the picking control using the selected end effector EF and the overview camera BCM is possible. In the picking control of the end effector EF, the control device P1 can further speed up the takt time of the picking work by minimizing the object Tg to be a target of the picking control using the hand camera HCM.

### Technique 3

In the control device P1 according to Technique 2,

the acquisition unit (the communication unit 10) acquires a picking result of the object using the second camera (the overview camera BCM), and

the control unit (the processor 11) updates the threshold value to a value less than the threshold value when the robot (the picking robot RB) succeeds in picking the object.

Accordingly, the control device P1 can optimize the threshold value for determining whether the picking control using the selected end effector EF and the overview camera BCM is possible. Therefore, the control device P1 can set the threshold value more suitable for the picking robot RB, and can determine with higher accuracy whether the picking control of the object Tg using only the overview camera BCM is possible.

### Technique 4

In the control device P1 according to Technique 2,

the acquisition unit (the communication unit 10) acquires a picking result of the object using the second camera (the overview camera BCM), and

the control unit (the processor 11) updates the threshold value such that the camera used to estimate the picking position of the object is changed from the second camera to the first camera based on a current threshold value when the robot (the picking robot RB) fails to pick the object.

Accordingly, the control device P1 can optimize the threshold value for determining whether the picking control using the selected end effector EF and the overview camera BCM is possible. Therefore, the control device P1 can set the threshold value more suitable for the picking robot RB, and can more effectively prevent picking failure of the object Tg due to a decrease in estimation accuracy of the picking position of the object Tg.

### Technique 5

In the control device P1 according to any one of Technique 1 to Technique 4,

the plurality of end effectors EF include at least a gripper GR and a suction pad PD.

Accordingly, the control device P1 according to the embodiment can realize the picking of the object Tg using the plurality of different end effectors EF.

### Technique 6

In the control device P1 according to any one of Technique 2 to Technique 4,

the plurality of end effectors EF include at least a gripper GR, and

the determination unit (the processor 11) calculates an interval between the object and an object around the object based on the captured image, and calculates a first evaluation value (the camera selection evaluation value) indicating the interval with respect to a size D1 of the gripper GR, when the selected end effector EF is the gripper GR.

Accordingly, the control device P1 according to the embodiment can evaluate, for each end effector EF, whether the overview camera BCM can be used in picking the object Tg. Therefore, the control device P1 can determine with higher accuracy whether the picking control of the object Tg using only the overview camera BCM is possible.

### Technique 7

In the control device P1 according to any one of Technique 2 to Technique 4,

the plurality of end effectors EF include at least a suction pad PD, and

the determination unit (the processor 11) calculates a size of the object based on the captured image, and calculates a second evaluation value (the camera selection evaluation value) indicating the size of the object with respect to a size (= W1 × W2) of the suction pad PD, when the selected end effector EF is the suction pad PD.

Accordingly, the control device P1 according to the embodiment can evaluate, for each end effector EF, whether the overview camera BCM can be used in picking the object Tg. Therefore, the control device P1 can determine with higher accuracy whether the picking control of the object Tg using only the overview camera BCM is possible.

### Technique 8

In the control device P1 according to any one of Technique 1 to Technique 7,

the acquisition unit (the communication unit 10) acquires the captured image captured by the second camera (the overview camera BCM).

Accordingly, since the control device P1 according to the embodiment can detect the object Tg using the overview camera BCM, as compared with the case of using the hand camera HCM, processing of bringing the end effector EF close to the object Tg is not required, and a time required for detecting the object Tg can be further shortened. In addition, when it is determined that the picking control of the object Tg using only the overview camera BCM is possible, the control device P1 can execute the picking work of the object Tg without using the hand camera HCM, and thus the takt time of the picking work can be further sped.

### Technique 9

A control method for a robot (the picking robot RB) performed by a control device P1 that controls a robot (the picking robot RB) for picking an object, includes:

acquiring a captured image;

detecting the object from the captured image;

selecting an end effector EF for picking the object from among a plurality of different end effectors EF included in the robot (the picking robot RB), based on the select object;

determining a camera to be used for estimating a picking position of the object from among a first camera (the hand camera HCM) that is provided integrally with the end effector EF and captures an image of the object and a second camera (the overview camera BCM) that is provided separately from the end effector EF and captures an image of an area where the object is picked, based on the captured image and information on the selected end effector; and

causing the robot (the picking robot RB) to pick the object using the determined first camera (the hand camera HCM) or second camera (the overview camera BCM) and the selected end effector EF.

Accordingly, when it is determined that the picking control using the overview camera BCM is possible based on the picking situation of the object with respect to the selected end effector EF, the control device P1 causes the picking robot RB to perform the picking control using the overview camera BCM. Therefore, in the picking control of the end effector EF, the control device P1 can further speed up the takt time of the picking work by minimizing the object Tg to be the target of the picking control using the hand camera HCM.

### Technique 10

A robot control system (the picking system 100) includes:

a robot (the picking robot RB) including a plurality of different end effectors EF and configured to pick an object;

a first camera (the hand camera HCM) provided integrally with the end effector EF and configured to capture an image of the object;

a second camera (the overview camera BCM) provided separately from the end effector EF and configured to capture an image of an area where the object is picked; and

a control device P1 configured to communicate with the robot (the picking robot RB), the first camera (the hand camera HCM), and the second camera (the overview camera BCM) and control the robot (the picking robot RB), in which

the second camera (the overview camera BCM) acquires a captured image, and

the control device P1:

detects the object from the captured image;

selects an end effector EF for picking the object from among the plurality of different end effectors EF based on the select object;

determines a camera to be used for estimating a picking position of the object from among the first camera (the hand camera HCM) and the second camera (the overview camera BCM), based on the captured image and information on the selected end effector; and

causes the robot (the picking robot RB) to pick the object using the determined first camera (the hand camera HCM) or second camera (the overview camera BCM) and the selected end effector EF.

Accordingly, when it is determined that the picking control using the overview camera BCM is possible based on the picking situation of the object with respect to the selected end effector EF, the picking system 100 causes the picking robot RB to execute the picking control using the overview camera BCM. Therefore, in the picking control of the end effector EF, the picking system 100 can further speed up the takt time of the picking work by minimizing the object Tg to be the target of the picking control using the hand camera HCM.

Although the embodiment has been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the various embodiments described above may be combined freely in a range without deviating from the spirit of the invention.

What is claimed is:

1. A control device that controls a robot for picking an object, the control device comprising:
an acquisition unit configured to acquire a captured image;
a detection unit configured to detect the object from the captured image;
a selection unit configured to select an end effector for picking the object from among a plurality of different end effectors included in the robot based on the detected object;
a determination unit configured to determine a camera to be used for estimating a picking position of the object from among a first camera that is provided integrally with the end effector and captures an image of the object and a second camera that is provided separately from the end effector and captures an image of an area where the object is picked, based on the captured image and information on the selected end effector; and
a control unit configured to cause the robot to pick the object using the determined first camera or second camera and the selected end effector.

2. The control device according to claim 1, wherein
the determination unit:
calculates an evaluation value indicating a picking situation of the object with respect to the end effector;
determines the camera as the first camera when being determined that the evaluation value is less than a threshold value corresponding to the end effector; and
determines the camera as the second camera when being determined that the evaluation value is not less than the threshold value corresponding to the selected end effector.

3. The control device according to claim 2, wherein
the acquisition unit acquires a picking result of the object using the second camera, and
the control unit updates the threshold value to a value less than the threshold value when the robot succeeds in picking the object.

4. The control device according to claim 2, wherein
the acquisition unit acquires a picking result of the object using the second camera, and
the control unit updates the threshold value such that the camera used to estimate the picking position of the object is changed from the second camera to the first camera based on a current threshold value when the robot fails to pick the object.

5. The control device according to claim 1, wherein
the plurality of end effectors include at least a gripper and a suction pad.

6. The control device according to claim 2, wherein
the plurality of end effectors include at least a gripper, and
when the selected end effector is the gripper, the determination unit:
calculates an interval between the object and an object around the object based on the captured image; and
calculates a first evaluation value indicating the interval with respect to a size of the gripper.

7. The control device according to claim 2, wherein
the plurality of end effectors include at least a suction pad, and
when the selected end effector is the suction pad, the determination unit:
calculates a size of the object based on the captured image; and
calculates a second evaluation value indicating the size of the object with respect to a size of the suction pad.

8. The control device according to claim 1, wherein
the acquisition unit acquires the captured image captured by the second camera.

9. A control method for a robot performed by a control device that controls a robot for picking an object, the control method comprising:
acquiring a captured image;
detecting the object from the captured image;
selecting an end effector for picking the object from among a plurality of different end effectors included in the robot, based on the select object;
determining a camera to be used for estimating a picking position of the object from among a first camera that is provided integrally with the end effector and captures an image of the object and a second camera that is provided separately from the end effector and captures an image of an area where the object is picked, based on the captured image and information on the selected end effector; and
causing the robot to pick the object using the determined first camera or second camera and the selected end effector.

10. A robot control system comprising:
a robot including a plurality of different end effectors and configured to pick an object;
a first camera provided integrally with the end effector and configured to capture an image of the object;
a second camera provided separately from the end effector and configured to capture an image of an area where the object is picked; and
a control device configured to communicate with the robot, the first camera, and the second camera and control the robot, wherein
the second camera acquires a captured image, and
the control device:
detects the object from the captured image;
selects an end effector for picking the object from among the plurality of different end effectors based on the select object;
determines a camera to be used for estimating a picking position of the object from among the first camera and the second camera, based on the captured image and information on the selected end effector; and
causes the robot to pick the object using the determined first camera or second camera and the selected end effector.
